(19) United States
(12) Patent Application Publication
(10) Pub. No.: US 2012/0248762 A1
(43) Pub. Date: Oct. 4, 2012

(54) Rotary and swivel connection for high-pressure systems

(76) Inventors: Franz Weinhandl, Weisslingen (CH); Maxim Levin, Weinheim (DE); Robert Szekeres, Bad Bergzabern (DE)

(21) Appl. No.: 13/332,941

(22) Filed: Dec. 21, 2011

(30) Foreign Application Priority Data
Dec. 23, 2010 (DE) 20 2010 016 929.1

(51) Int. Cl. F16L 37/52

(52) U.S. Cl. 285/147.1

(57) ABSTRACT

A rotary and swivel connection comprising two swivelable housing parts, wherein a channel in a first housing part is formed by a hollow shaft positioned rotatably about a rotary axis corresponding to a longitudinal axis of the first housing part, the hollow shaft, with a bearing lug, extending into a opening in the second housing part for holding the housing parts together, the second housing part being swivelable about a swivel axis perpendicular to the rotary axis of the hollow shaft, and the second housing part having an axis section non-rotatably connected to the hollow shaft and forming a channel, positioned as a swivel axis for the second housing part such that when the hollow shaft rotates in the first housing part, the second housing part rotates together with the axis section, and the channels are connected to each other in all swivel directions.

The invention relates to a rotary and swivel connection for high-pressure systems such as high-pressure pumps, hose lines or tools, consisting of two held-together housing parts swivelable toward each other about a swivel axis and each having at least one external terminal for a component of a high-pressure system, with each housing component being provided with one through-channel for the fluid flowing in the high-pressure system.

In the case of high-pressure systems made up of several components, the individual components are connected to one another in a standard way using threaded connections causing them to be rigidly connected. This may make the handling of a high-pressure spray gun, connected to a high-pressure pump via a high-pressure hose, for instance, very difficult. Because of their design high-pressure hoses are not very flexible, making handling of connected equipment difficult, and a rigid connection may also lead to twisting or kinking of the high-pressure hose when handling the components. There is a need, therefore, to design the connection for the individual components to one another such that unimpeded handling of the components is possible without undue exertion of strength.

A swivel connection is already known from U.S. Pat. No. 4,437,690 A, which provides for the swiveling of two housing parts, each of which is connectable by an external connector to varying components of a high-pressure system, about a swivel axis running perpendicular to a common longitudinal axis of the connected components. Each housing part contains an angular conduit, and the housing parts are placed side by side and connected to one another via a connecting means forming the swivel axis, so that the parts angling away from the connection direction of the external connectors of the respective conduit are flush with each other. Since such a swivel connection cannot, however, compensate for rotation or twisting of the components about their longitudinal axis, the swivel possibility of the housing parts alone is not sufficient.

Furthermore, a rotary connection for hoses is known from EP 0 232 178 A2, where the hose ends of the hoses are attached to each other such that rotation of the hoses about their longitudinal axis is possible. For this to be possible, a special coupling sleeve is provided in which the hose ends whose fronts abut each other are enclosed by a common bearing part and a pipe-shaped sealing element connecting the conduits of the hoses at the hose ends and bridging the butt joint between the hose ends is positioned. This connection, in turn, does not permit swiveling of the hose ends from a common hose longitudinal axis and also has a complicated configuration.

The object of the invention, therefore, is to provide a connection of components of a high-pressure system, which components permit rotation as well as swiveling of the components, and have an easy-to-handle configuration.

This object, including advantageous configurations and extensions of the invention, is achieved as described in the patent claims following this description.

The basic principle of the invention is that in a first housing part a hollow shaft forming the latter's through-channel is positioned rotatably about a rotary axis corresponding to its longitudinal axis in the first housing part, and that the hollow shaft, with a bearing lug, extends into a receiving opening in the second housing part for holding the housing parts together, and the second housing part around the bearing lug is swivelable about a swivel axis running perpendicular to the rotary axis of the hollow shaft, where in the second housing part an axis section, non-rotatably connected to the hollow shaft and forming a through-channel, is positioned as a swivel axis for the second housing part such that when the hollow shaft rotates in the first housing part, the second housing part rotates together with the axis section carried along by the hollow shaft, and that the through-channel of the hollow shaft and the through-channel of the axis section are connected to each other in all swivel directions of the second housing part to the first housing part.

The invention facilitates rotation of each of the components connected to the external connectors of the first and second housing part toward each other, because the housing parts are rotatable relative to each other about a rotary axis formed in the one housing part due to the rotatable setup of the hollow shaft. While the non-rotatable connection between the rotatable hollow shaft and the axis section fixed in the second housing part allows the hollow shaft in the first housing part to be rotated at will, with the second housing part rotating along with it, the second housing part, in turn, can be rotated vis-a-vis the first, for instance fixed, housing part via the rotation of the hollow shaft connected to the axis section of the second housing part. At the same time, swiveling of the second housing part about the axis section positioned therein and fixed as a result of the connection to the hollow shaft and serving as a swivel axis, is possible, so that the two housing parts—in addition to being mutually rotatable—can also assume varying angle positions to each other. Consequently, the rotary and swivel connection according to the invention simultaneously provides two degrees of freedom in the alignment to one another of components of a high-pressure system.

According to one exemplary embodiment of the invention, the bearing lug of the hollow shaft is configured circularly with an inner eye and the through-channel of the hollow shaft opens into the eye, and that the axis section of the second housing part is inserted into the inner eye of the circular lug of the hollow shaft, and the through-channel formed in the axis section is angled in the direction of the through-channel of the hollow shaft opening into the eye of the bearing lug. This way, the axis section fixed in the second housing part is connected non-rotatably to the hollow shaft, so that the hollow shaft and the second housing part always rotate in unison.

Provided that it is important that the through-channel formed in the hollow shaft is always in contact with the through-channel in the axis section aligned at an angle with the hollow shaft, it is proposed that in the area of the axis section inserted in the inner eye of the hollow shaft a cross hole is positioned at a right angle to its longitudinal axis and along the course of the rotary axis of the hollow shaft, and a groove is fashioned around the outer circumference of the axis section, into which groove the two ends of the cross bore open. The fluid-conducting groove formed in the axis section and connected to the through-channel of the hollow shaft ensures that even a rotation of the axis section inserted into the bearing lug of the hollow shaft toward the longitudinal axis of the hollow shaft containing the corresponding through-channel provides a connection of the through-channels in hollow shaft and axis section because, above the annulus and the cross hole connected on both sides, there exists a connection between the through-channels of hollow shaft and axis section in every rotational position of the axis section.

With regard to the allocation of the external terminals of first and second housing part to each other, it may be proposed to position the terminals across from each other on the rotary axis of the hollow shaft, and in the second housing part, a connecting channel between the external terminal of the second housing part and the end of the through-channel formed in the axis section running at a right angle to the rotary axis of the hollow shaft located in the first housing part.

Regarding the rotatable position of the hollow shaft in the first housing part, it may be proposed, according to an exemplary embodiment of the invention, to rotatably place the hollow shaft in the first housing part on a ball bearing between the hollow shaft and the first housing part. The ball bearing may be braced axially against forces axially acting on the hollow shaft via a disk arrangement positively engaging the hollow shaft and the housing part.

To ensure against radial widening, it may further be proposed that the first housing part is encompassed in the area of the ball bearing and disk arrangement by a screwed-on housing nut on the outside.

The swivel bearing of the second housing part about the axis section contained therein may be implemented by the second housing part being swivelably supported about the swivel axis formed by the axis section via two ball bearings located on opposite sides of the axis section in relation to the rotary axis of the hollow shaft passing through at a right angle to the axis section, where it may be proposed that the ball bearings are radially prestressed via a threaded socket screwed into an assembly opening formed in the direction of the axis section in the second housing part.

When implementing the invention, various swivel positions of the second housing part toward the first housing part must be established, depending on the configuration of the opening receiving the bearing lug. According to one embodiment of the invention, therefore, it may be proposed to have the opening for the bearing lug of the hollow shaft in the second housing part extend over the width of the second housing part in the swivel plane lying at a right angle to the swivel axis, so that pivoting of the second housing part toward the first housing part around 180°. Alternatively, it may be proposed to configure the opening for the bearing lug of the hollow shaft in the second housing part with a boundary edge oriented obliquely in the swivel plane lying at a right angle to the swivel axis such that swiveling of the second housing part toward the first housing part by 90° is possible unidirectionally. Any other swivel angle is configurable by an appropriate design of the receiving opening in the second housing part.

The drawing shows exemplary embodiments of the invention, as described below.

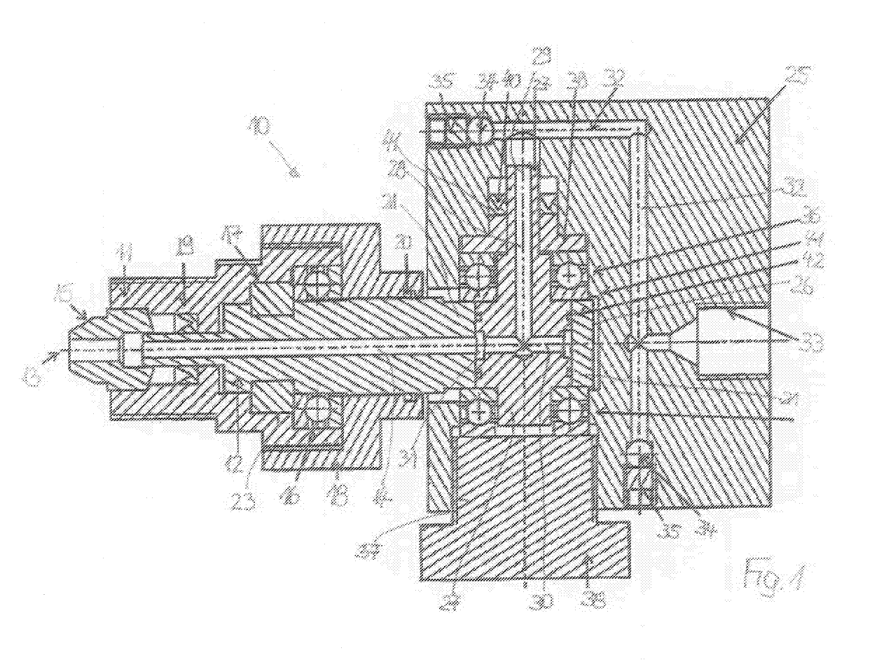

FIG. 1 A rotary and swivel connection for high-pressure systems with two housing parts having one external terminal each, in sectional view,

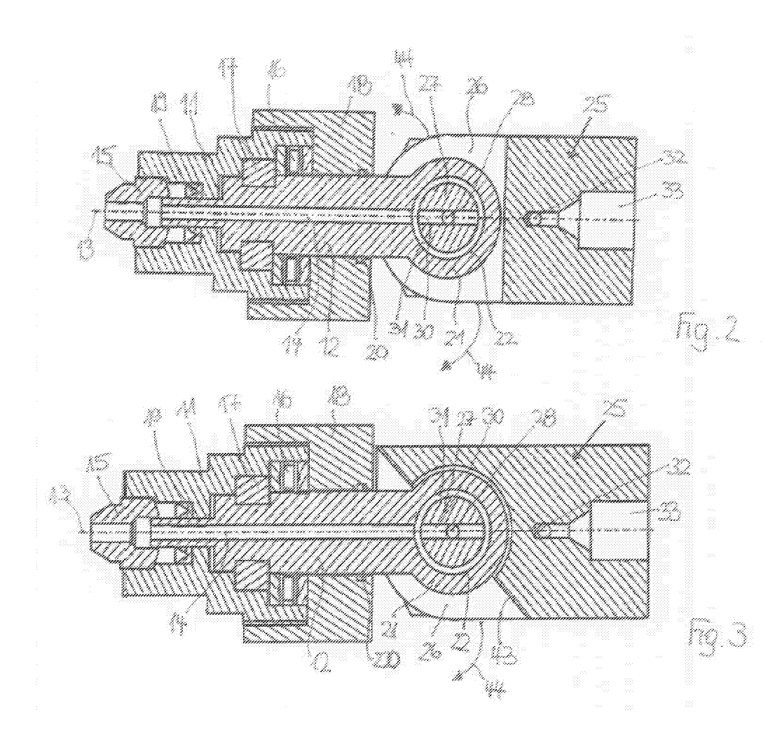

FIG. 2 the two housing parts in sectional view, rotated by 90° in relation to FIG. 1, in a first embodiment,

FIG. 3 the object of FIG. 2 in an amended embodiment.

Rotary and swivel connection 10 as seen in FIG. 1 has a first housing part 11 on whose (left) end a connection sleeve 15 is mounted as external terminal for a component of a high-pressure system. In first housing part 11, a hollow shaft 12 allocated to connection sleeve 15 is rotatably positioned about its longitudinal axis which acts as rotary axis 13, with hollow shaft 12 having a through-channel 14 within, axially extending from connection sleeve 15. For a rotatable support of hollow shaft 12, first housing part 11 has installed a ball bearing 16 encircling hollow shaft 12 on the outside, which ball bearing is axially fixed or supported in the first housing part via a support disk setup 17. Support disk setup 17, preferably in the form of two half shells, engages recess 23 formed on the outer circumference of hollow shaft 12, ensuring axial fixing of hollow shaft 12 with ball bearing 16 in first housing part 11. Furthermore, first housing part 11, in the area of ball bearing 16 and support disk setup 17, is encompassed on the outside by housing nut 18 screwed onto first housing part 11, ensuring radial support of ball bearing 16 encircling hollow shaft 12. A line contact between connection sleeve 15 and first housing part 11, as well as seal 19 located in first housing part 11 and encircling hollow shaft 12, seal first housing part 11 and hollow shaft 12 toward the outside; in addition, to further seal hollow shaft 12 against the environment, an O-ring 20, encircling hollow shaft 12 on the outside, is placed in the area where housing nut 18 encircles hollow shaft 12.

Hollow shaft 12 projects, with bearing lug 21, over first housing part 11 or housing nut 18 on the side opposite connection sleeve 15, with bearing lug 21 being set up for connection of a second housing part 25 which, on its side lying opposite housing part 11, has an external terminal 33, configured as a hole with internal thread, for connecting an additional component of the high-pressure system. Second housing part 25 is slipped on bearing lug 21 of hollow shaft 12 via a receiving opening 26 contained therein. In second housing part 25, there is an assembly hole 41 having a rectangular pathway to rotary axis 13 of hollow shaft 12. Into this assembly hole 41, an axis section 27 is inserted which engages inner eye 22 of bearing lug 21 of hollow shaft 12, causing second housing part 25 to be non-rotatably connected to hollow shaft 12 which is rotatably positioned in housing part 11. Axis section 27 is inserted from an external assembly opening 37 formed in the longitudinal axis of assembly hole 41.

For forming a flow path for the medium to be guided through rotary and swivel connection 10, axis section 27 also has a through-channel 28 along its longitudinal axis, with the longitudinal axis of axis section 27 forms, together with through-channel 28, a swivel axis 29 for swiveling second housing part 25 relative to first housing part 11. Insofar as through-channel 14 of hollow shaft 12 and through-channel 28 of axis section 27 are oriented at a right angle to each other, a cross hole 30 is situated in the axis section 27 at the inner end of through-channel 28 such that cross hole 30 is flush with through-channel 14 of hollow shaft 12. In order to facilitate a fluidic connection of second housing part 25 to first housing part 11 in varying swivel positions, a rotary groove 31, connecting the ends of cross hole 30 to each other, is located on the outer circumference of axis section 27, with through-channel 14 of hollow shaft 12 opening into groove 31 of axis section 27, so that in all swivel positions of second housing part 25 with axis section 27 toward first housing part 11 with hollow shaft 12 there is a fluid connection between through-channel 14 of hollow shaft 12 and through-channel 28 of axis section 27 via groove 31 and cross hole 30 originating therefrom. For sealing axis section 27 against the interior surface of eye 22 of bearing lug 21, O-rings 42 are used on the outer circumference of axis section 27 on both sides of the terminal of through-channel 14 of hollow shaft 12.

Through-channel 28 of axis section 27 running at a right angle to the longitudinal axis of external terminal 33 formed in second housing part 25 is connected to external terminal 33 via connecting channel 32 located in second housing part 25 at a corresponding angle. Insofar as the two sections of connecting channel 32, positioned at a right angle to each other, are each to be inserted into the second housing part from different sides of housing part 25, the outer ends of the connecting channel sections are each closed using a ball 34 with a screw 35.

For creating a swivel bearing for swiveling second housing part 25 toward first housing part 11, ball bearings 36 are positioned between second housing part 25 and axis section 27 inserted into assembly hole 41 of second housing part 25 on both sides of rotary axis 13 of hollow shaft 12 in first housing part 11, so that second housing part 25 is swivelable aboutd swivel axis 29 that is non-rotatably coupled to first housing part 11 by the insertion of axis section 27 into inner eye 22 of bearing lug 21 of hollow shaft 12. Here, the ball bearing setup rests, in axial direction of hollow shaft 12, on support disk 39 placed in the deepest part of graduated assembly hole 41 especially configured for this purpose, while on the opposite side a threaded socket 38 is screwed into assembly opening 37 forming the outer exit of assembly hole 41, via which opening the application of force on both ball bearings 36 is adjustable. At the lowest point of assembly hole 41, there is also a seal 40 which seals the exit of through-channel 28 of axis section 27 and its connection to connecting channel 32 of second housing part 25 against support disk setup 39 with the abutting ball bearing. During operation, the pressure of the medium flowing through through-channel 14 of hollow shaft 12 and connecting channel 32 of second housing part 25 is transferred to ball bearing setup 36 via seal 40 and support disk setup 39.

In the case of rotary and swivel connection 10 shown in FIG. 1, a common rotation of housing parts 11 and 25 toward connection sleeve 15 as an external terminal of the rotary and swivel connection is initially possible on a first component of a high-pressure system. If, for instance, torsion of the first component of a high-pressure system takes place, this rotation may take place unimpeded by a rotation of hollow shaft 12 connected to connection sleeve 15 within first housing part 11, with this rotation being converted into a rotation of the second housing part via axis section 27 of the second housing part, which axis section is inserted into inner eye 22 of bearing lug 21 of hollow shaft 12, as long as second housing part 25 always rotates together with hollow shaft 12. At the same time, however, in every rotational position of hollow shaft 12 to first housing part 11, swiveling of second housing part 25 toward first housing part 11 or alignment of hollow shaft 12 about swivel axis 29 can also take place as is shown in FIGS. 2 and 3, for instance.

In FIG. 2 it is shown that receiving opening 26 for bearing lug 21 of hollow shaft 12 extends, in second housing part 25, across the width of second housing part 25 above the swivel plane positioned at a right angle to swivel axis 29, so that swiveling of second housing part 25 toward first housing part 11 by an angle larger than 120° in the direction of arrows 44 is possible.

With such a configuration of the receiving opening, however, the strength of second housing part 25 is limited due to receiving opening 26 extending across the width of second housing part 25. Since the medium flowing through through-channel 14 of hollow shaft 12 exerts an axial force when reaching axis section 27, acting on the combination of axis section 27 and threaded socket 38, a bending moment occurs on the inside of receiving opening 26 which may cause high tensions in second housing part 25. In order to better accept this bending moment, in the exemplary embodiment shown in FIG. 3, receiving opening 26 is configured with a boundary edge 43 lying obliquely to rotary axis 13 of hollow shaft 12, so that in this case swiveling of second housing part 25 toward first housing part 11 to only one side by an angle of up to 90° in the direction of arrow 44 is possible.

The characteristics of the object of these documents disclosed in the preceding description, the patent claims, the abstract and the drawing may be significant individually, as well as in any combination for implementing the invention in its various configurations.

1. Rotary and swivel connection for high-pressure systems such as high-pressure pumps, hose lines or tools, consisting of two held-together housing parts swivelable toward each other and each having at least one external terminal for a component of a high-pressure system, with each housing component being provided with one through-channel for the fluid flowing in the high-pressure system,
wherein in a first housing part a hollow shaft forming the latter's through-channel is positioned rotatably about a rotary axis corresponding to its longitudinal axis in the first housing part, and that the hollow shaft, with a bearing lug, extends into a receiving opening in the second housing part for holding the housing parts together, and the second housing part around the bearing lug is swivelable about a swivel axis running perpendicular to the rotary axis of the hollow shaft, where in the second housing part an axis section, non-rotatably connected to the hollow shaft and forming a through-channel, is positioned as a swivel axis for the second housing part such that when the hollow shaft rotates in the first housing part, the second housing part rotates together with the axis section carried along by the hollow shaft, and that the through-channel of the hollow shaft and the through-channel of the axis section are connected to each other in all swivel directions of the second housing part to the first housing part.

2. Rotary and swivel connection as recited in claim 1, wherein the bearing lug of the hollow shaft is configured circularly with an inner eye and the through-channel of the hollow shaft opens into the eye, and that the axis section of the second housing part is inserted into the inner eye of the circular lug of the hollow shaft, and the through-channel formed in the axis section is angled in the direction of the through-channel of the hollow shaft opening into the eye of the bearing lug.

3. Rotary and swivel connection as recited in claim 2, wherein a cross hole is positioned in the area of the axis section inserted into the inner eye of the hollow shaft at a right angle to its longitudinal axis and along the course of the rotary axis of the hollow shaft, and a groove is fashioned around the outer circumference of the axis section, into which groove the two ends of the cross hole open.

4. Rotary and swivel connection as recited in claim 1, wherein the external terminals of first housing part and second housing part are located opposite each other on the rotary axis of the hollow shaft, and in the second housing part a connecting channel is formed between the external terminal of the second housing part and the end of the through-channel running at a right angle to the rotary axis of the hollow shaft located in the first housing part and formed in the axis section.

5. Rotary and swivel connection as recited in claim 1, wherein the hollow shaft in the first housing part is rotatably supported by a ball bearing located between hollow shaft and housing part.

6. Rotary and swivel connection as recited in claim 5, wherein the ball bearing is braced axially against forces axially acting on the hollow shaft via a disk arrangement positively engaging the hollow shaft and the housing part.

7. Rotary and swivel connection as recited in claim 5, wherein the first housing part is encompassed in the area of ball bearing and disk arrangement on its outside by a screwed-on housing nut.

8. Rotary and swivel connection as recited in claim 1, wherein the second housing part is swivelably supported about the swivel axis formed by the axis section via two ball bearings located on opposite sides of the axis section in relation to the rotary axis of the hollow shaft passing through at a right angle to the axis section.

9. Rotary and swivel connection as recited in claim 8, wherein the ball bearings are radially prestressed via a threaded socket screwed into an assembly opening formed in the direction of the axis section in the second housing part.

10. Rotary and swivel connection as recited in claim 1, wherein the that receiving opening for the bearing lug of the hollow shaft extends, in the second housing part, across the width of second housing part above the swivel plane positioned at a right angle to the swivel axis, so that swiveling of the second housing part toward first housing part by an angle larger than 120° is possible.

11. Rotary and swivel connection as recited in claim 1, wherein the receiving opening for the bearing lug of the hollow shaft in the second housing part is configured with a boundary edge oriented obliquely in the swivel plane lying at a right angle to the swivel axis such that swiveling of the second housing part toward the first housing part by 90° is possible unidirectionally.
